(19) United States
(12) Patent Application Publication
(10) Pub. No.: US 2005/0211723 A1
(43) Pub. Date: Sep. 29, 2005

(54) Pack of plastic bags having side openings

(76) Inventor: Rafael A. Alvarado, Houston, TX (US)

Correspondence Address: G. Alan Witte;Frost Bank Building, Suite 920, 6750 West Loop South, Houston, TX, 77401, US

(21) Appl. No.: 10/808,238

(22) Filed: Mar. 24, 2004

(51) Int. Cl. B65D 33/14; G07F 11/16; B65H 3/00; B65G 59/00

(52) U.S. Cl. 221/268

(57) ABSTRACT

A pack of plastic bags having a plurality of bag units, each bag unit having a disposable upper portion and a lower bag portion, wherein the lower bag portion has an opening with a reclosable seal located on the side.

### BACKGROUND OF THE INVENTION

1. Field of the Invention

The present invention relates to a pack of plastic bags having a plurality of bag units, each bag unit having a disposable upper portion and a lower bag portion, wherein the lower bag portion has an opening with a reclosable seal located on the side.

2. Description of the Related Art

In supermarkets, department stores and other retail outlets, there is frequently the need for consumers or store employees to place items in bags to facilitate handling and purchase. For example, produce bags are dispensed directly to customers wherein the customer can bag the produce as it is chosen for purchase. Also, in deli or meat departments, store employees place the selected meats or other deli products in bags for the consumer. In the prior art, there are a number of designs for dispensing bags for these purposes.

Roll mounted produce bags are commonly found in modem grocery stores and supermarkets. These bags are designed for customers to use when purchasing fresh produce. The bags currently available are difficult for customers to use for several reasons. First, the bags tend to cling together and are difficult to separate from the roll. Second, it is difficult to tell the open end of the bag from the closed end of the bag. Third, the bags are difficult to open, as the sides tend to cling together.

U.S. Pat. No. 5,732,833, commonly owned by applicant, discloses a dispensing assembly for supporting packs of plastic bags. The packs of plastic bags include a disposable upper portion connected to the lower bag portion. A perforation is made between the disposable upper portion and the lower bag portion. When a customer wants to use a plastic bag, he pulls on the lower bag portion and tears it away from the disposable upper portion at the perforation. While these plastic bags are suitable and cost-effective for a number of situations, in other situations these plastic bags suffer from some shortcomings. For example, with these bag dispensing systems it frequently requires two hands to pull the bag down and open it. Also, often more than one bag is removed, resulting in wasted bags.

U.S. Pat. No. 5,682,730 discloses a pack of plastic bags provided with a zipper. To facilitate mounting, handling, and filling of the plastic bags, the bags include a bottom header. The bottom header includes one or more openings for mounting the plastic bags to dispensing posts. If these packs of plastic bags are hung in a vertical position, the zipper would run along the bottom of the pack of plastic bags. There are number of shortcomings associated with these packs of plastic bags having a zipper on the bottom. For example, to use these bags, the bag must first be removed from the pack before the product is put in the bag. This usually requires two hands, requiring the product be set down while the bag is removed from the pack and opened.

Applicants are also aware of prior art packs of plastic bags where, when the pack is hung in a vertical position from support hooks, a zipper runs along the top of the bag. This prior art pack suffers from the shortcoming that, due to the thickness of the zipper and slider, the pack is very bulky near the top, making it difficult to place product in the bag when the bag is hanging in a vertical position.

Thus, there are a number of shortcomings with the known rolls of plastic bags and packs of plastic bags. A common problem with dispensing bags is providing one bag to the consumer or store employee in a convenient, simple, and reliable fashion. Further considerations relate to uniformity of dispensing bags, ease of opening, and ease of filling.

### SUMMARY OF THE INVENTION

Accordingly, a need has arisen for a pack of plastic bags which can easily be opened, filled, and sealed.

In accordance with the present invention, a pack of plastic bags is provided comprising a plurality of bag units, each bag unit having a disposable upper portion and a lower bag portion, a binder formed by joining together the disposable upper portions of the plurality of bag units, each bag unit having a serration between the disposable upper portion and the lower bag portion, each lower bag portion having a side and a bottom, and each lower bag portion having an opening with a reclosable seal located on the side.

Accordingly, an object of the present invention is to provide a pack of plastic bags wherein the bags have an opening on the side such that a user can place a product in the bag while the bag is hanging in a vertical position.

### BRIEF DEDSCRIPTION OF THE DRAWINGS

A better understanding of the invention can be obtained when the detailed description of exemplary embodiments set forth below is considered in conjunction with the attached drawings in which:

FIG. 1 is a front view of an individual bag unit.

FIG. 2 is a front view of a headerless pack of plastic bags having holes through the binder.

FIG. 3 is a front view of a pack of plastic bags having a header for attaching the pack to at least one support hook.

FIG. 4 is a magnified cross-sectional view of a zipper having a single seal.

FIG. 5 is a magnified cross-sectional view of a zipper having a double seal.

### DETAILED DECRIPTION OF THE EXEMPLARY EMBODIMENTS

The present invention relates to a pack of plastic bags. While the pack of plastic bags may be used for any purpose, the preferred use of the pack of plastic bags is at a deli counter. With the preferred use, a store employee places deli meats or other deli products in a bag, removes and seals the bag, and provides the bag with the deli products to the customer.

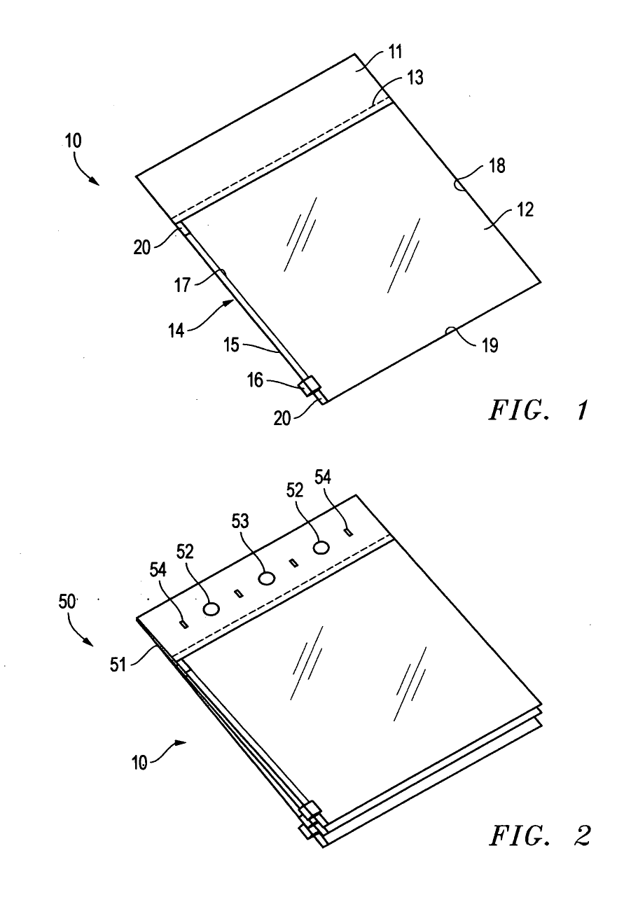

With reference to FIG. 1, an individual bag unit 10 is shown having an upper disposable portion 11 and a lower bag portion 12. The upper disposable portion 11 and the lower bag portion 12 are separated by a serration 13. The serration 13 allows the lower bag portion 12 to be easily separated from the upper disposable portion 11. Each lower bag portion 12 has an opening 14 having a reclosable seal 15. Preferably, the reclosable seal 15 is a zipper having a slider 16. When looking at an individual bag unit 10 from the front, each lower bag portion 12 has a left side 17, a right side 18, and a bottom 19. The seal 15, which is preferably a zipper, has stops 20 which serve to limit to the travel of the slider 16 and aid in sealing the lower bag portion 12.

With reference to FIG. 2, a pack of plastic bags 50 is shown wherein a number, preferably about fifty, of individual bag units 10 are joined together to form a pack 50. In forming the pack 50, the individual bag units 10 are stacked on top of each other, with the openings 14 and reclosable seals 15 located on the same side, and the upper disposable portion 11 of each individual bag unit 10 are joined together to form a binder 51. The binder 51 may be formed in any suitable way; however, preferably, the binder 51 is formed by inserting heated blunt rods through the upper disposable portions 11 of the stack of bag units 10 to melt the upper disposable portions 11 together about the points of insertion 54. The insertion of a heated blunt rod serves to melt the plastic immediately adjacent to the point of insertion 54. In FIG. 2, the points of insertion 54 show that small rectangular heated blunt rods were used to melt plastic in the upper disposable portions 11 to form the binder 51. However, any shape of heated blunt rod would be suitable for this purpose. Thus, insertion of heated blunt rods melts the plastic in the upper disposable portion 11 and joins together the upper disposable portions 11 of the individual bag units 10. As is discussed in more detail below, preferably, the pack of plastic bags 50 is attached on one or more support hooks (not shown, see commonly owned U.S. Pat. No. 5,732,833, herein incorporated by reference) and hung vertically. One way of attaching the pack of plastic bags 50 to the one or more support hooks is by placing one or more holes, shown as side holes 52 and center hole 53, through the binder 51. The side holes 52 are utilized when two support hooks are used; the center hole 53 is utilized when one support hook is used. The holes 52, 53 may be cut out of the upper disposable portions 11 or formed with the use of heated blunt rods as discussed above and as is known in the art.

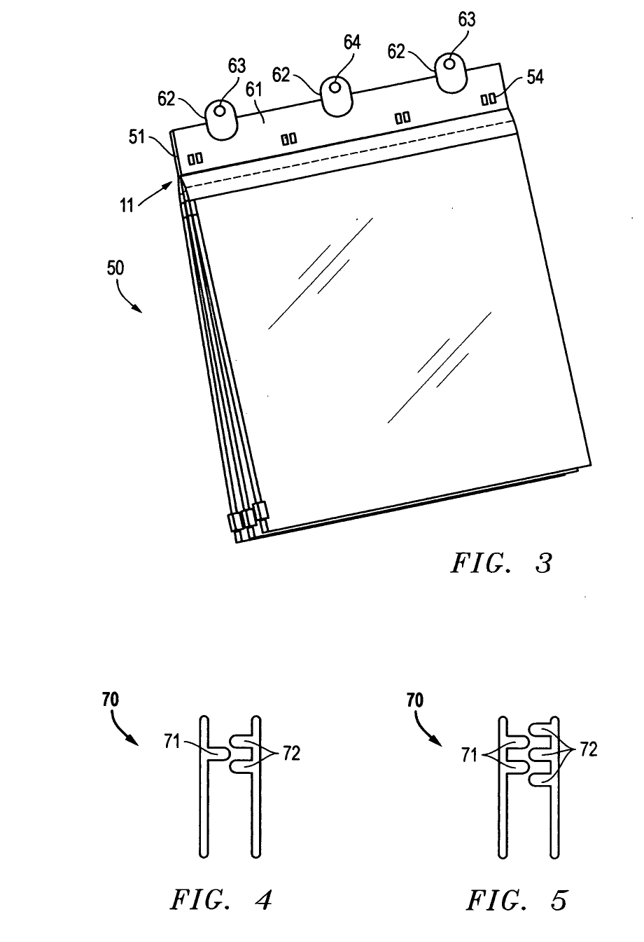

With reference to FIG. 3, a pack of plastic bags 50 is shown having a header 61. The header 61 is formed by cutting a flat, generally rectangular plastic piece and folding the rectangular plastic piece longitudinally in half to substantially cover the binder 51. A number of tabs 62 are cut from the header 61 (prior to folding the header 61 in half) and side holes 63 and center hole 64 are placed in the tabs 62. The header 61 is attached to the upper disposable portions 11 of the bag units 10 and covers the binder 51. The header 61 is attached to the upper disposable portion 11 and the header 51 by any suitable means. One such means of attaching the binder 61 is by inserting heated blunt rods to form points of insertion 54 where, as discussed above, the plastic is melted in the area immediately adjacent to the point of insertion 54 which binds the upper disposable portions 11 together to form the binder 51 covered by the header 61.

The embodiment shown in FIG. 2 is generally known in the industry as a “headerless” pack of plastic bags 50, while the pack of plastic bags 50 shown in the embodiment of FIG. 3 is generally known in the industry to include a “header”, shown as header 61. The header 61 provides rigidity and resistance to bending which tends to eliminate any tendency of the pack 50 to curl about a vertical axis of the pack 50. Also, the header 61 facilitates handling and hanging of the pack of plastic bags 50 upon one or more support hooks. Further, with a header, the individual bag units 10 are much less likely to separate from each other at binder 51, i.e., the header 61 holds the upper disposable portions 11 together more securely as compared with the headerless binder 51.

The present invention provides an attaching means for attaching the pack 50 to at least one support hook. As discussed above, the holes 52, 53 in the headerless binder 51 provides one means for attaching the pack 50 to at least one support hook. Also as discussed above, the header 61 has tabs 62 having holes 63, 64 which serve to hang the pack 50 upon one or more support hooks. Preferably, the side holes 52, 63 are designed to be 3 inches apart.

The present invention provides a closure means for sealing each bag located on one side of the lower bag portion 12. Preferably, the closure means is a zipper having a slider 16. Also, the closure means may be the “press together” seal known in the art wherein a person uses his fingers to start sealing a bag and slides his fingers along the seal to complete the seal.

Most preferably, the plurality of bag units 10 are provided in an open position with the opening 14 on the left side 17 of the lower bag portion 12 with the slider 16 at the bottom 19 of lower bag portion 12. The positioning of the opening 14 on the side of the lower bag portion 12, and particularly on the left side 17, has been found to provide significant advantages over prior art bag dispensers. For example, behind a deli counter, the slicing equipment is typically set up where the employee uses his right hand to move a large piece of deli meat back and forth into contact with the slicing blade, while using his left hand to catch the slices of the deli meat. Thus, the deli counter employee will have slices of deli meat in his left hand which he wishes to package for the customer. The present invention allows the deli counter employee to place his left hand containing the sliced deli meat in the opening 14 of the lower bag portion 12 while the bag is still hanging on the support hooks. After placing the deli meat in the bag, the deli counter employee then has both hands free to remove the bag from the pack 50 and to seal the bag. Also, a deli counter employee may use a knife or other cutting instrument, generally in his right hand, to cut cheese or other deli products. Typically, since the deli counter employee's right hand is occupied, he will pick up the cheese or other deli product in his left hand. Again, the present invention allows the deli counter employee to place his left hand containing the cheese or other deli product in the opening 14 of the lower bag portion 12 while the bag is still hanging on the support hooks. While it is preferable to have the opening 14 and the seal 15 on the left side 17 of the lower bag portion 12, to achieve some of the advantages of the present invention, the opening 14 and the seal 15 may be provided on the right side 18 of the lower bag portion 12. Also, many of the advantages of the present invention may be achieved if the slider 16 is located at the top of the lower bag portion 12.

As noted above with regard to the prior art pack of plastic bags shown in U.S. Pat. No. 5,682,730, if this pack of plastic bags was hung in the vertical position from support hooks, the zipper would run along the bottom of the pack of plastic bags. This presents several significant shortcomings as compared with the present invention. As noted above, with the present invention, a product may be placed in the bag while the bag is still hanging on the support hooks. With the prior art pack of plastic bags shown in U.S. Pat. No. 5,682,730, it is not possible to place product in the bag while the bag is hanging in a vertical position (i.e., the product would fall out of the opening at the bottom of the bag). Thus, in using this prior art pack of plastic bags, one must remove the bag from the pack prior to placing the product in the bag. If a deli counter employee has a deli product in his left hand, he would typically set the deli product down on the counter, retrieve a bag, then place the product in the bag. Thus, the present invention eliminates one or more steps in the process of packaging deli products.

Applicant is also aware of prior art packs of plastic bags where, when the pack is hung in a vertical position from support hooks, the zipper runs along the top of the bag. Due to the thickness of the zipper and slider, these packs tend to be very bulky at the top of the bag, making it difficult to place product in the bag while the bag hangs in a vertical position.

With reference to FIG. 4 and FIG. 5, a magnified cross-sectional view of a zipper 70 is shown. The FIG. 4 embodiment shows a zipper 70 having one male profile runner 71 and two female profile runners 72 which when sealed creates a single seal. The FIG. 5 embodiment shows a zipper 70 having two male profile runners 71 and three female profile runners 72 which 30 when sealed create a double seal. The double seal serves to provide a better overall seal when the zipper 70 is used, for example, in liquid service.

The material used to create the plastic bags may be any suitable plastic resin, including low density polyethylene; linear low density polyethylene; high density polyethylene; high molecular weight, high density polyethylene; and polypropylene. Also, the material used to create the bags may be a single extruded layer or a plastic film comprising multiple, coextruded layers.

The present invention is advantageous over known packs of plastic bags. The present invention provides a pack of plastic bags which, when hanging in a vertical position, presents a bag having an opening and a seal on the side. This allows the user to place a product in the bag while the bag is hanging in a vertical position. After the product is placed in the bag, the user then has two free hands to remove the bag from the pack and to seal the bag. As discussed above, other prior art packs of plastic bags are more difficult to use and/or require additional steps to remove, fill and seal the bags.

Having described the invention above, various modifications will be apparent to those skilled in the art. It is intended that all such variations within the scope and spirit of the invention be included within the scope of the appended claims.

1. A pack of plastic bags, comprising:
a plurality of bag units, each bag unit having a disposable upper portion and a lower bag portion;
a binder formed by joining together the disposable upper portions of the plurality of bag units;
each bag unit having a serration between the disposable upper portion and the lower bag portion;
each lower bag portion having a side and a bottom; and
each lower bag portion having an opening with a reclosable seal located on the side.

2. The pack of plastic bags of claim 1, wherein the reclosable seal is a zipper having a slider.

3. The pack of plastic bags of claim 2, wherein each lower bag portion is provided in an open position with the slider at the bottom of the lower bag portion.

4. The pack of plastic bags of claim 1, wherein the opening is on a left side.

5. The pack of plastic bags of claim 1, wherein the opening is on a right side.

6. The pack of plastic bags of claim 1, wherein the binder has at least one hole for supporting the pack of plastic bags on at least one support hook.

7. The pack of plastic bags of claim 1, wherein the binder is formed by inserting at least one heated blunt rod through the disposable top portions of the plurality of bag units to bind the disposable top portions together.

8. The pack of plastic bags of claim 1, further comprising a header adhered to the binder, the header having at least one hole for supporting the pack of plastic bags on at least one support hook.

9. The pack of plastic bags of claim 8, wherein the header is formed from a substantially rectangular piece of plastic folded longitudinally.

10. The pack of plastic bags of claim 1, wherein the reclosable seal is a zipper having one runner on a first side and two runners on a second side.

11. The pack of plastic bags of claim 1, wherein the reclosable seal is a zipper having two runners on a first side and three runners on a second side.

12. The pack of plastic bags of claim 1, wherein the reclosable seal is a press together seal.

13. A pack of plastic bags, comprising:
a plurality of bag units, each bag unit having a disposable upper portion and a lower bag portion;
a binder formed by joining together the disposable upper portions of the plurality of bag units;
each bag unit having a serration between the disposable upper portion and the lower bag portion;
each lower bag portion having a side, a bottom, and an opening;
a closure means for sealing each bag located on the side of the lower bag portion; and
an attaching means for attaching the pack to at least one support hook.

14. The pack of plastic bags of claim 13, wherein the closure means is a zipper having a slider.

15. The pack of plastic bags of claim 14, wherein each lower bag portion is provided in an open position with the slider at the bottom of the lower bag portion.

16. The pack of plastic bags of claim 13, wherein the opening is on a left side.

17. The pack of plastic bags of claim 13, wherein the opening is on a right side.

18. The pack of plastic bags of claim 13, wherein the attachment means for attaching the pack to at least one support hook comprises the binder having at least one hole.

19. The pack of plastic bags of claim 13, wherein the binder is formed by inserting at least one heated blunt rod through the disposable top portions of the plurality of bag units to bind the disposable top portions together.

20. The pack of plastic bags of claim 13, wherein the attachment means for attaching the pack to at least one support hook comprises a header adhered to the binder, the header having at least one hole.

21. The pack of plastic bags of claim 20, wherein the header is formed from a substantially rectangular piece of plastic folded longitudinally.

22. The pack of plastic bags of claim 13, wherein the reclosable seal is a zipper having one runner on a first side and two runners on a second side.

23. The pack of plastic bags of claim 13, wherein the reclosable seal is a zipper having two runners on a first side and three runners on a second side.

24. The pack of plastic bags of claim 13, wherein the reclosable seal is a press together seal.

25. In a pack of plastic bags of the type having a plurality of bag units, each bag unit having a disposable upper portion and a lower bag portion with a serration between the disposable upper portion and the lower bag portion, the plurality of bag units bound together by joining the disposable upper portions of the plurality of bag units, the pack of plastic bags being designed to hang on at least one support hook, the improvement comprising:
each lower bag portion having a side and a bottom, each lower bag portion having an opening with a reclosable seal located on the side.

26. The pack of plastic bags of claim 25, wherein the reclosable seal is a zipper having a slider.

27. The pack of plastic bags of claim 25, wherein each lower bag portion is provided in an open position with the slider at the bottom of the lower bag portion.

28. The pack of plastic bags of claim 25, wherein the opening is on a left side.
